(19) United States
(12) Patent Application Publication
(10) Pub. No.: US 2016/0265258 A1
(43) Pub. Date: Sep. 15, 2016

(54) SLIDING DOOR SYSTEM FOR GLASS DOORS

(71) Applicant: SBPL SYSTEMS INC., Mille-Isles (CA)

(72) Inventor: Serge BOUTHILLIER, Ste-Marthe-sur-le-Lac (CA)

(21) Appl. No.: 15/066,486

(22) Filed: Mar. 10, 2016

Related U.S. Application Data
(60) Provisional application No. 62/133,029, filed on Mar. 13, 2015.

(51) Int. Cl. E05D 15/06

(52) U.S. Cl. CPC E05D 15/063; E05D 15/0652

(57) ABSTRACT

A roller unit for a sliding door comprises a connector assembly adapted to be secured to a sliding door. The connector assembly comprises a spindle. A wheel is mounted to the spindle of the connector assembly for rotation about the spindle, a circumferential groove defined in the wheel and configured for receiving an upwardly-facing edge portion of a transom. A tab projects from the connector assembly, the tab having an upwardly-facing surface adapted to be positioned under and vertically aligned with a downwardly-facing surface of the transom, a gap between the upwardly-facing surface and the downwardly-facing surface being equal or less than a depth of the circumferential groove. The roller unit holds the sliding door captive vertically on the transom while permitting translational movement of the door by rotation of the wheel about the spindle along the transom.

### CROSS-REFERENCE TO RELATED APPLICATION

The present application claims priority of U.S. Provisional Patent Application No. 62/133,029, filed on Mar. 13, 2015, and incorporated herein by reference.

### FIELD OF THE APPLICATION

The present application relates to sliding door systems for glass doors, and more particularly to a roller unit to support the glass door and allow the sliding motion of the door.

### BACKGROUND OF THE ART

Nowadays, glass and similar see-through or translucent materials are used as structural components. In that glass allows light to pass through, doors, walls and structures made from glass represents an esthetic and elegant solution. However, in these instances, the glass components must have minimum thicknesses, as they serve a structural function.

Accordingly, hinges and sliding door mechanisms must be capable of handling the weight of movable components (e.g., doors). On the other hand, due to the highly esthetic value of glass doors and structures, and the fact that they are often transparent, sliding door mechanisms must be visually appealing. It is therefore desired to reduce the number of hardware pieces.

Due to the weight of the glass sliding doors, various configurations have been used in the past to prevent derailment of the glass sliding door. The configurations have included using tandem sets of roller units on opposite sides of transoms, and this increases the number of roller units. Another known configuration has been to hold a roller captive between a pair of transoms, or in slots machined into a transom.

### SUMMARY OF THE APPLICATION

It is therefore an aim of the present disclosure to provide a sliding door system for glass doors that addresses issues associated with the prior art.

Therefore, in accordance with the present application, there is provided a roller unit for a sliding door comprising: a connector assembly adapted to be secured to a sliding door, the connector assembly comprising a spindle, a wheel mounted to the spindle of the connector assembly for rotation about the spindle, a circumferential groove defined in the wheel and configured for receiving an upwardly-facing edge portion of a transom, and a tab projecting from the connector assembly, the tab having an upwardly-facing surface adapted to be positioned under and vertically aligned with a downwardly-facing surface of the transom, a gap between the upwardly-facing surface and the downwardly-facing surface being equal or less than a depth of the circumferential groove; whereby the roller unit holds the sliding door captive vertically on the transom while permitting translational movement of the door by rotation of the wheel about the spindle along the transom.

Further in accordance with the present application, there is provided a sliding door system comprising: a transom adapted to be secured to a structure above a door opening and having at least an upwardly-facing edge portion and a downwardly-facing surface; at least one glass door; at least two roller units secured to the door to top hand the door onto the transom, each of the two roller units comprising a connector assembly secured to the glass door, the connector assembly comprising a spindle, and a wheel mounted to the spindle of the connector assembly for rotation about the spindle, a circumferential groove defined in the wheel and receiving the upwardly-facing edge portion of a transom, wherein at least one of the two roller units has a tab projecting from the connector assembly, the tab having an upwardly-facing surface positioned under and vertically aligned with the downwardly-facing surface of the transom, a gap between the upwardly-facing surface and the downwardly-facing surface being equal or less than a depth of the circumferential groove; whereby the roller units hold the at least one glass door captive from vertical derailing off the transom while allowing translational movement of the door via rolling movement of the wheels along the transom.

### BRIEF DESCRIPTION OF THE DRAWINGS

FIG. 1 is a perspective view of a sliding door system in accordance with an embodiment of the present disclosure;

FIG. 2 is an exploded view of a roller unit of the sliding door system of FIG. 1;

FIG. 3 is a sectional view of the roller unit of FIG. 2 on a transom;

FIG. 4 is a perspective view of an intermediate member supporting the transom as in FIG. 1; and

FIG. 5 is a perspective view of another intermediate member supporting the transom as in FIG. 1.

### DESCRIPTION OF THE PREFERRED EMBODIMENTS

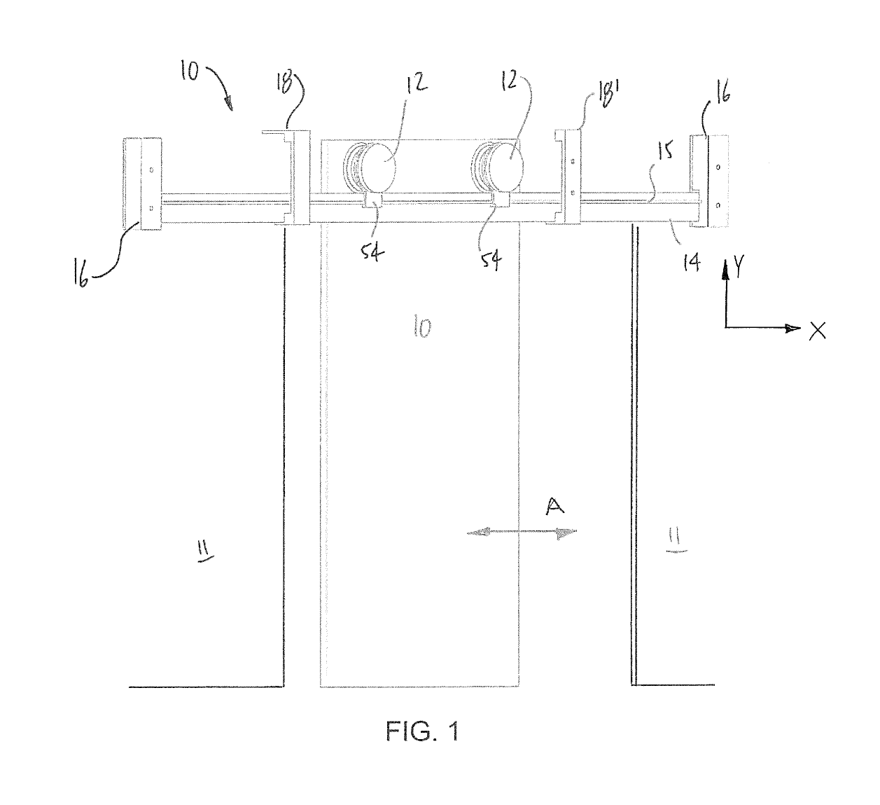

Referring to the drawings and more particularly to FIG. 1, a sliding door system in accordance with the present disclosure is generally shown having a sliding door 10 made of a glass panel. The sliding door 10 translates to open/close an opening in a structure 11 along its main plane, in the directions shown by A, and this is commonly known as “sliding”, although there is little or no actual sliding movement, the expression being commonly used as the door 10 appears to slide. In the present case, even though the glass sliding door 10 is supported by roller units and therefore rolls, the expression sliding door is nonetheless used as per convention. The structure 11 is typically made of glass panels as well, but may also consist of any other suitable materials or combination of materials, or dwelling partitions.

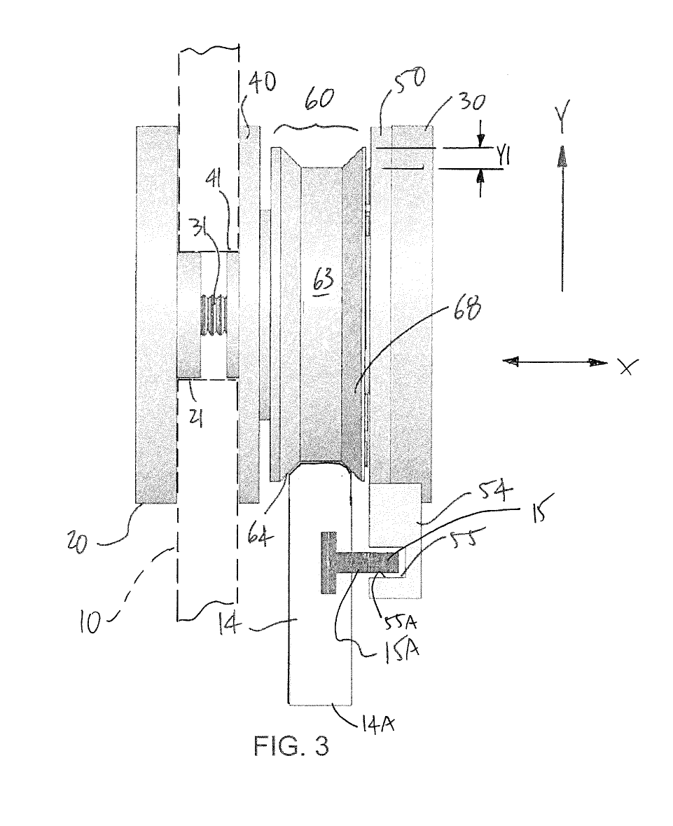

In FIG. 1, the door 10 is shown supported by a pair of roller units 12. However, any appropriate number of roller units 12 above a pair may be used to support a sliding door. The door 10 is top-hung by roller units 12 onto a transom 14, also known as transverse beam, support beam, support rail, horizontal bar or beam, etc. The transom 14 may be part of the structure 11 or structurally secured to it, and is typically a beam made of a material with suitable structural integrity, such as a metal. As observed in FIG. 3, the transom 14 may have a railing 15. In an embodiment, the transom 14 is an extruded member, with the railing 15 being slid into the cavity of the extruded member. Alternatively, the railing 15 could be a monolithic part of the transom 14. As yet another embodiment, the transom 14 could have a guide channel therein, for instance in an elongated cavity formed by extrusion, or machined subsequently. As an example, the transom 14 may be secured to surrounding structure (e.g., walls) by end members 16, above a door opening defined by the structure 11. Intermediate members 18 may be used to provide additional support to the transom 14, retain the transom 18 against flexure. The intermediate members 18 are typically connected to a ceiling or other horizontal structure (beam, etc). However, the transom 14 may be used without such intermediate member 18, for instance if the transom 14 spans a relatively short length, or if the transom 14 is constructed with high rigidity materials.

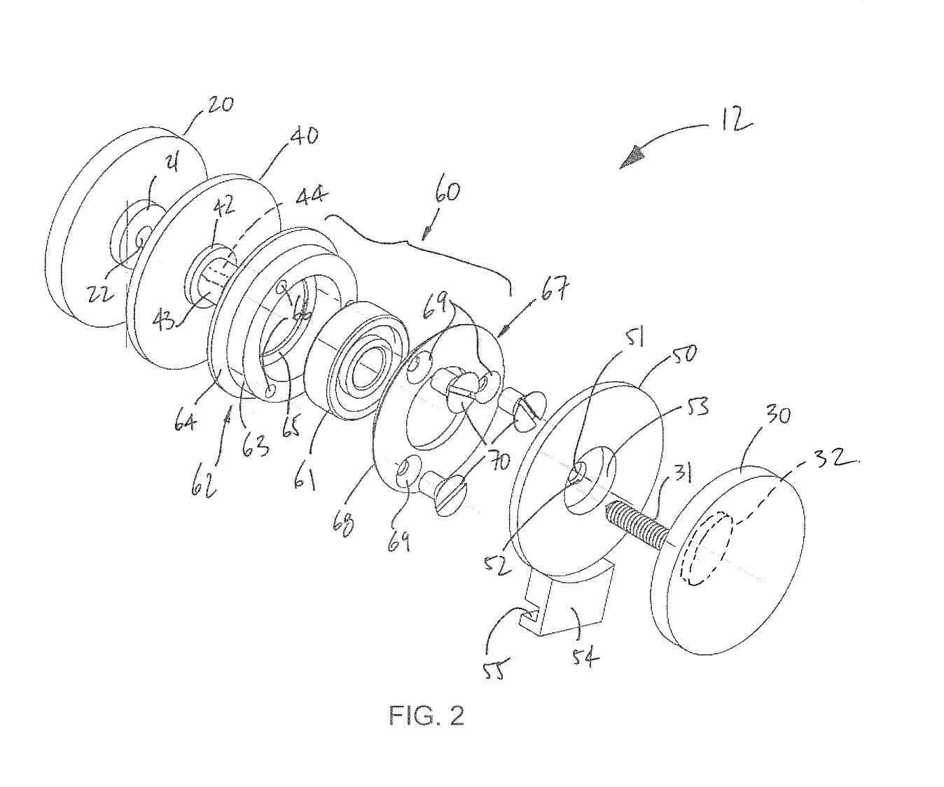

Referring concurrently to FIGS. 2 and 3, one of the roller units 12 is shown in greater detail. As described hereinafter, the roller unit 12 has a connector assembly rotatably supporting a wheel, the connector assembly interfacing the glass sliding door 10 to the wheel, with the wheel rolling along the transom 14.

Now describing in detail its numerous components, the roller unit 12 has an end cap 20. The end cap 20 is visible when the roller unit 12 is assembled to a door, whereby the end cap 20 may have any appropriate ornamental features: paint, finish, ornaments. Moreover, the end cap 20 may have other shapes than that of a disk.

A neck 21 projects from one of the circular surfaces of the end cap 20, and will be received in a bore in the glass door 10, whereby the neck 21 interfaces the door 10 to the roller unit 12. The neck 21 has a tapped bore 22, preferably not extending through the cap 20, for the outer surface of the end cap 20 to be smooth and continuous without a bore disruption. In the illustrated embodiment, the neck 21 and the tapped bore 22 are concentric with the end cap 20.

Referring to FIGS. 2 and 3, another end cap 30 is provided on the opposed end of the roller unit 12. The end cap 30 is visible when the roller unit 12 is assembled to a door, whereby the end cap 20 may have any appropriate ornamental features and shape. The end cap 30 has a fastener 31—such as a threaded rod—projecting concentrically therefrom, and fixed to the end cap 30. Therefore, when the roller unit 12 is assembled, the fastener 31 is threadingly engaged into the tapped bore 22 of the end cap 20. The reverse arrangement is possible as well, with the fastener integral with the end cap 20 and the end cap 30 providing the tapped bore. The end cap 30 may also have a neck 32 at the base of the fastener 31.

The rolling components of the roller unit 12 are positioned between the end caps 20 and 30. The end caps 20 and 30 define the visible face portions of the roller units 12. Therefore, barring exception, the components of the roller unit 12 sandwiched between the end caps 20 and 30 are designed to have diametrical dimensions equal or smaller than that of the end caps 20 and 30, to be concealed therebetween.

Referring to FIGS. 2 and 3, the roller unit 12 has a middle disk 40. The middle disk 40 has a neck 41 (FIG. 3) facing the neck 21, with both necks 21 and 41 having a same diameter. Like the neck 21, the neck 41 will be received in a bore in the door 10, whereby the neck 41 interfaces the door 10 to the roller unit 12. Another neck 42 may project from the opposite side of the middle disk 40, with a spindle 43 projecting axially from the neck 42. The neck 42 and spindle 43 are preferably concentric with the middle disk 40.

A throughbore 44 passes through the middle disk 40, the necks 41, 42, and the spindle 43, for the fastener to reach the end cap 20 by passing through the throughbore 44. The throughbore 44 is concentric with the necks 41, 42 and spindle 43, and may or may not be threaded.

In order to secure the roller unit 12 to a bore in a structural panel or in a door, the end cap 20 and middle disk 40 are positioned on opposite sides of the bore, in such a way that the necks 21 and 41, respectively, enter into the bore and may contact one another, effectively sandwiching the door 10 therebetween. It is contemplated to have a single one of the necks 21 and 41 instead of a pair of the necks 21 and 41, with the single neck being long enough to extend through the bore in the door 10 to contact the disk 20 or 40 on the other side. O-rings may be placed in peripheral shoulders about the cap 20 and disk 40 beforehand, so as not to have the circular surfaces of the cap 20 and disk 40 come in direct contact with the glass sliding door 10. Moreover, the O-rings are preferably made of a resilient rubbery material, to generally dampen transmission of vibrations between the panel and the roller unit 12. Such O-rings may prevent water infiltration between the cap 20 and disk 40 and the glass sliding door 10. The O-rings or like rings of resilient material may be received in grooves on the circular surfaces alternatively to the peripheral shoulders. It is also contemplated to have a roller unit 12 without the disk 40. The disk 40 assists in interfacing the roller unit 12 to the door 10, and spaces and isolates the wheel from contact with the door 10, but other arrangement are also considered, without the disk 40.

A guard member, such as a guard disk 50 is located inward of the end cap 30. The guard disk 50 has a neck 51 with throughbore 52 for the passage of the fastener 31 through it. A full bore or counterbore 53 may be provided in the neck 51, and is sized to receive therein the neck 32 of the end cap 30. In this way, a mating engagement is defined between the end cap 30 and the guard disk 50, thereby creating a robust interconnection therebetween, with negligible or no play, but with a rotation movement being possible (although not necessary), about an axis coincident with that of the spindle 43. A guard tab 54 projects from a periphery of a disk body of the guard disk 50, and may be oriented downwardly by the rotational adjustment being possible. The guard tab 54 has a guide channel 55 in which is received the railing 15 of the transom 14. In an embodiment, there may be contact between the guard tab 54 and the railing 15, thereby resulting in a translational joint therebetween. Alternatively, there is close proximity, but no contact, between the guard tab 54 and the railing 15, during normal sliding operation of the door 10 along the transom 14. The guard disk 50 may be a monolithic component that has a relatively low coefficient of friction, in the event of contact with the railing 15. In an embodiment, the guard disk 50 is made with a high-density rigid plastic. Alternatively, the guard tab 54 could be connected to the end cap 30, to the middle disk 40 or to any other part of the connector assembly, provided some mechanism or joint is provided to ensure the guard tab 54 projects downwardly.

Referring to FIGS. 2 and 3, a wheel 60 of the roller unit 12 is between the end cap 30 and the middle disk 40. The wheel 60 has a bearing 61, which may be any suitable type of bearing (e.g., roller bearing, ball bearing), and preferably of rolling-element bearing as opposed to sleeve bearings. Alternatives to rolling-element bearings may be used as well, such as annular rings of low-friction materials (e.g., PTFE) and the like. The bearing is mounted on the spindle 43 of the middle disk 40, although the spindle could be integral with the end cap 20 or 30 as well, for example if there is no middle disk 40. The neck 41 of the middle disk 40 and the neck 51 of the guard disk 50 may abut against the inner race of the bearing 61 to remove any axial play.

The wheel 60 may have a first wheel ring 62 having an annular body that is positioned adjacent to the middle disk 40 when the roller unit 12 is assembled. The wheel ring 62 has a cylindrical surface portion 63 and a flared surface portion 64. The flared surface portion 64 is positioned adjacent to the middle disk 40 when the roller unit 12 is assembled. An inner shoulder 65 projects radially inwardly from the flared surface portion 64, in the opening of the wheel ring 62. The inner shoulder 65 is provided to define a seat in the wheel ring 62 for the outer race of the bearing 61. Tapped bores 66 are defined in an axial surface of the wheel ring 62, and are used to connect a second wheel ring 67 to the first wheel ring 62.

Referring to FIGS. 2 and 3, the second wheel ring 67 has an annular body and is positioned adjacent to the guard disk 50 when the roller unit 12 is assembled (although the inversion is considered, second wheel ring 67 being adjacent to the middle disk 40). The wheel ring 67 has a flared surface portion 68. Countersink holes 69 are defined axially through the wheel ring 67, and are spaced apart so as to be in register with the tapped bores 66. Accordingly, with appropriate fasteners 70 (e.g., with a countersunk head), the first wheel ring 62 and the second wheel ring 67 are secured to one another. An inner diameter of the wheel ring 67 is similar to that of the inner shoulder 65, and smaller than an outer diameter of the bearing 61, whereby the bearing 61 is held captive in the first wheel ring 62.

Although not shown, a spacer may be provided to increase the width of the wheel 60. The spacer may have a cylindrical ring body having an outer diameter similar to that of the cylindrical surface portion 63 of the first wheel ring 62. The width of the wheel 60 is selected as a function of the thickness of the transom 14, and the availability of spacers of different thickness can be used to adapt wheels 60 to different transom thicknesses. Axial throughbores would be defined in the spacer, to allow the connection of the first wheel ring 62 and the second wheel ring 67 with fasteners 70, as described above.

As best seen in FIG. 3, the wheel 60 therefore has the shape of a sheave, with the flared surface portions 64 and 68 acting as flanges, and the cylindrical surface portion 63 (optionally with a spacer) forming the groove between the flanges. Accordingly, when a transom having the appropriate shape is in contact with the wheel 60, it is held captive by the sheave shape, i.e., by the peripheral groove (a.k.a., peripheral groove) on the wheel 60. The complementary interaction between the transom 14 and the wheel 60, with the engagement of an edge portion of the transom 14 in the peripheral groove of the wheel 60, removes or reduces any lateral play between the transom 14 and the wheel 60, i.e., in direction X. To better illustrate the various components, FIG. 3 shows no contact between the transom 14 and the wheel 60, but evidently the wheel 60 sits on the transom 14 during use.

Although a modular construction of the wheel 60 is described, it is pointed out that the wheel 60 may be an integral piece (e.g., cast, machined, or the like). However, the modular construction allows the wheel 60 to be adapted to various thicknesses of panels (e.g., 6 mm to 25 mm), by simply selecting appropriate spacer width. Accordingly, the modular construction addresses inventory issues. It is pointed out that through the description, reference is made to tapped bores and throughbores. This includes self-tapping bores.

Referring to FIG. 3, the sectional view of the roller unit 12 on the transom 14 shows the interaction between the guard tab 54 of the disk 50 and the railing 15. The interaction is such that the roller unit 12 is held captive onto the transom 14 in the vertical direction shown as Y. Indeed, the roller unit 12 rests on an upwardly oriented horizontal surface of the transom 14, as its wheel 60 sits on the upper edge of the transom 14, but also abuts against or is in close proximity to a downwardly oriented horizontal surface of the transom 14, in this case by the arrangement of the guard tab 54 and the underside 15A of the railing 15. Therefore, the glass sliding door 10 may not be dislodged accidentally from its top-hung connection to the transom 14 as a result of vertical impact, because of the arrangement described above. Instead, to remove the glass sliding door 10 from its connection to the transom 14, the glass sliding door 10 must be disconnected from the roller units 12. Moreover, the removal of the play in the X and Y axes because of the configuration of the roller units 12 and transom 14 may also block the door 10 from rotating out of engagement with the transom 14, about a Z-axis (cross-product of the vectors of the X-axis and the Y-axis). It is therefore observed that the presence of the guard tab 54 is used instead of a top transom 14 or a tandem set of roller units 12 aligned vertically and on opposite sides of the transom 14, both solutions previously used to remove the play in the Y-axis, and to prevent rotation about the Z-axis. FIG. 3 indeed shows the door 10 in use with a single transom 14 (without a top transom), and the door 10 having a single horizontal row of roller units 12, i.e., at the same height (with tandem roller units aligned on a same vertical axis at different heights).

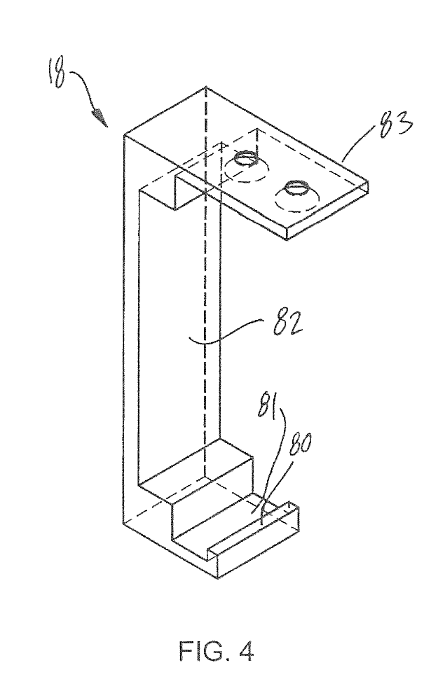

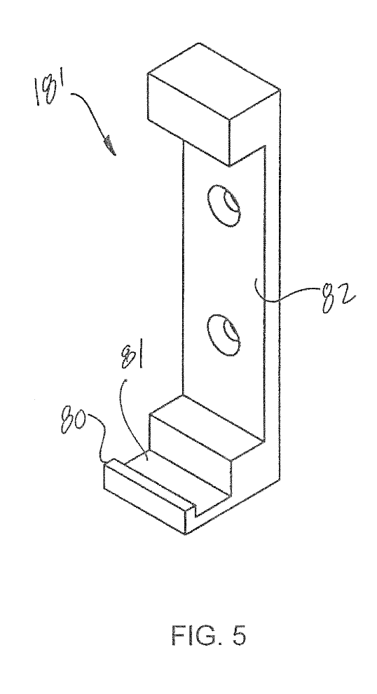

Referring to FIGS. 4 and 5, the intermediate member 18/18′ is illustrated in two different configurations. The expression “intermediate” is used to refer to the positioning of the member 18/18′ between ends of the transom 14 (centered or off-centered). The intermediate member 18/18′ are used when the transom 14 spans a relatively large opening. Similarly to the end members 16, the intermediate member 18/18′ has sufficient structural strength to support part of the weight of the glass sliding doors 11, for instance by way of a solid body of a metallic material. The intermediate member 18 has an elongated vertical body with hook 80 projecting laterally from a bottom of the elongated vertical body. The tips of the hook 80 is inward, defining grooves 81 for receiving the transom 14 and generally preventing lateral movements of the transom 14. A slot 82 is defined in the elongated vertical body. The slot 82 is sized so as to allow the roller unit 12 with guard tab 54 to pass therethrough, the slot 82 also receiving the railing 15 therein. Hence, the intermediate member 18 will provide structural support to the transom 14, while not blocking the movement of the roller unit 12. In the version of the intermediate member 18 of FIG. 4, a flange 83 is located at a top of the elongated vertical body of the intermediate member 18. The flange 83 may have bores to receive fasteners, and thus allow the intermediate member 18 to be secured to a ceiling or like structure above the intermediate member 18.

The intermediate member 18′ of FIG. 5 is similar in configuration to the intermediate member 18 of FIG. 4, whereby like elements will bear like reference numerals. The intermediate member 18′ differs from the intermediate member 18 in that fastener-receiving bores are in the vertical body, as an alternative to the flange 83. The fastener-receiving bores are used to connect the intermediate member 18′ to a wall parallel to the rear face of the intermediate member 18′. In an embodiment, the intermediate member 18′ is connected to a lintel or beam.

As an alternative arrangement, the guard tab 54 may extend to the bottom edge of the transom 14, instead of cooperating with the railing 15. In such an embodiment, the intermediate members 18/18′ must either be absent or positioned away from displacement limits of the door 10 so as not to block the movement of the roller units 12. In such a case, the intermediate members 18/18′ could be used as limit stops.

Now that the examples of construction of roller units have been described, a use of the roller units 12 in a door system is set forth. Once the transom 14 is installed using end members 16 and, when necessary, intermediate members 18/18′, partial roller units 12, i.e., the components from the end cap 30 to the middle disk 40, are installed on the transom 14. In the process, the guard tab is installed to receive the railing 15 in its guide channel 55. If the glass sliding door 10 requires two of the roller units 12, both are installed in the manner described above.

Once the roller units 12 are on the transom 14 from the end cap 30 to the middle disk 40, the glass sliding panel 10 may be mounted onto the roller units 12, with bores in the glass sliding panel 10 receiving the neck 41. While the glass sliding panel 10 is still supported (e.g., manually), the end caps 20 may be screwed into engagement with a remainder of the roller units 12, with the fastener received in the tapped bore 22 of the end cap 20. Ultimately, the necks 21 and 41 will contact one another, the glass sliding door 10 will be sandwiched between the end cap 20 and the middle disk 40. Other fasteners, such as set screws, may be provided to lock the various components of the roller unit 12 together. The glass sliding door 10 may therefore move along its main plane, with the guard tab 54 moving along the railing 15 in the process.

In an alternative mounting procedure, the sliding door 10 with partial roller units 12 (i.e., including the end cap 20, the middle disk 40 (if present), and the wheel 60 mounted to the spindle 43 is top hung to the transom 14, with assistance considering that the wheel 60 is free to move axially on the spindle 43. When the door 10 is top hung, the guard tab 54 and the end cap 30 may be installed to complete the assembly of the roller unit 12.

While the roller unit 12 is shown as having a guard channel 55 receiving the railing 15, the guard tab 54 may have a projecting member instead of receiving the projecting railing 15. For example, as mentioned above, the guard tab 54 may have a projecting portion cooperating with a lower edge 14A or underside 15A of the transom 14 to block axial movement in the Y-axis. Therefore, any arrangement by which a structural connector assembly of the roller unit 12 (as opposed to the wheel 60) has an upwardly facing surface face to face and in close proximity or contact with a downwardly facing surface of the transom 14. If there is no contact between the upwardly facing surface (in this case, shown at 55A in FIG. 3) and the downwardly facing surface of the transom 14 (in this case shown as 15A), the close proximity may mean a gap having a height equal or less than a depth Y1 of the circumferential groove in the wheel 60. It is also considered to provide a single one of the roller units 12 on a single door 10 with the guard tab 54.

1. A roller unit for a sliding door comprising:
a connector assembly adapted to be secured to a sliding door, the connector assembly comprising a spindle,
a wheel mounted to the spindle of the connector assembly for rotation about the spindle, a circumferential groove defined in the wheel and configured for receiving an upwardly-facing edge portion of a transom, and
a tab projecting from the connector assembly, the tab having an upwardly-facing surface adapted to be positioned under and vertically aligned with a downwardly-facing surface of the transom, a gap between the upwardly-facing surface and the downwardly-facing surface being equal or less than a depth of the circumferential groove;
whereby the roller unit holds the sliding door captive vertically on the transom while permitting translational movement of the door by rotation of the wheel about the spindle along the transom.

2. The roller unit according to claim 1, wherein the tab has a guide channel defining the upwardly-facing surface, the guide channel configured to receive a railing of the transom defining the downwardly-facing surface.

3. The roller unit according to claim 2, wherein the guide channel is adapted to form a sliding joint with the railing of the transom.

4. The roller unit according to claim 1, wherein the tab is connected to the connector assembly by a rotation joint.

5. The roller unit according to claim 1, wherein the connector assembly has a first end adapted to be secured to the door, and an end cap at a second end, the wheel being mounted to the spindle between the door and the end cap.

6. The roller unit according to claim 5, further comprising a guard disk rotatably connected to the end cap and being located between the end cap and the wheel, the tab projecting from the guard disk.

7. The roller unit according to claim 6, wherein the end cap has a cylindrical neck projecting from a disk body, the guard disk having a bore therein, the cylindrical neck and the bore concurrently forming a rotational joint.

8. A sliding door system comprising:
a transom adapted to be secured to a structure above a door opening and having at least an upwardly-facing edge portion and a downwardly-facing surface;
at least one glass door;
at least two roller units secured to the door to top hand the door onto the transom, each of the two roller units comprising
a connector assembly secured to the glass door, the connector assembly comprising a spindle, and
a wheel mounted to the spindle of the connector assembly for rotation about the spindle, a circumferential groove defined in the wheel and receiving the upwardly-facing edge portion of a transom,
wherein at least one of the two roller units has a tab projecting from the connector assembly, the tab having an upwardly-facing surface positioned under and vertically aligned with the downwardly-facing surface of the transom, a gap between the upwardly-facing surface and the downwardly-facing surface being equal or less than a depth of the circumferential groove;
whereby the roller units hold the at least one glass door captive from vertical derailing off the transom while allowing translational movement of the door via rolling movement of the wheels along the transom.

9. The sliding door system according to claim 8, wherein the tab has a guide channel defining the upwardly-facing surface, and the transom has a railing projecting from a lateral surface thereof and defining the downwardly-facing surface, the guide channel receiving the railing of the transom.

10. The sliding door system according to claim 9, wherein the guide channel forms a sliding joint with the railing of the transom.

11. The sliding door system according to claim 9, wherein the railing is on the lateral surface of the transom facing away from the glass door.

12. The sliding door system according to claim 8, wherein the tab is connected to the connector assembly by a rotation joint.

13. The sliding door system according to claim 8, wherein the connector assembly of each said roller unit has a first end secured to the door, and an end cap at a second end, the wheel being mounted to the spindle between the glass door and the end cap.

14. The sliding door system according to claim 13, further comprising a guard disk rotatably connected to the end cap in at least one of the roller units, and being located between the end cap and the wheel, the tab projecting from the guard disk.

15. The sliding door system according to claim 14, wherein the end cap has a cylindrical neck projecting from a disk body, the guard disk having a bore therein, the cylindrical neck and the bore concurrently forming a rotational joint.

16. The sliding door system according to claim 8, wherein each said roller unit has one of said tab.
